(19) United States
(12) Patent Application Publication
(10) Pub. No.: US 2014/0143218 A1
(43) Pub. Date: May 22, 2014

(54) Method for Crowd Sourced Multimedia Captioning for Video Content

(71) Applicant: APPLE INC., Cupertino, CA (US)

(72) Inventors: Mehul K. Sanghavi, Sunnyvale, CA (US); Ravindra M. Phulari, Santa Clara, CA (US); Michael P. Greenzeiger, Santa Clara, CA (US)

(73) Assignee: Apple Inc., Cupertino, CA (US)

(21) Appl. No.: 13/681,467

(22) Filed: Nov. 20, 2012

(51) Int. Cl. G06F 17/30

(52) U.S. Cl. CPC G06F 17/3023
USPC 707/695

(57) ABSTRACT

Methods and apparatus are presented for providing enhancement information associated video, for example subtitles or closed captions. Cue points are developed with respect to a video and enhancement information is aligned with the cue points such that the cue point and enhancement information may be maintained separate from the video and applied to any version of a video. Some disclosed embodiments relate to using groups of volunteers to provide and edit enhancement information in a five stage process. The volunteer groups may be operated in a crowd sourcing fashion.

### FIELD OF THE DISCLOSURE

The subject matter of the present disclosure relates to computing systems and more particularly the use of a dispersed work forces, such as a crowd source, to provide enhancement information (e.g. closed captions) for audio/visual works.

### BACKGROUND OF THE DISCLOSURE

The invention relates generally to software, apparatus and techniques to enhance the viewer experience with video or audio/video works. One example of a technique to enhance the user experience is the use of close captioning or subtitling, which allow video works to be enjoyed by a wider audience. Close captioning is generally a technique for associating text with video so that a user can selectively view the text at appropriate times during the video play. For example, a hearing disabled person may select close captioning while viewing a video in order to understand dialog or other audible content that accompanies a video. Subtitles differ somewhat from captions in that they are typically used for transliteration and are often displayed persistently through a video, without a user selection.

In order to enhance video with features such as close captioning and subtitles, machine or human intervention is required at least to create the enhancement and to align it with the appropriate portion of the video. Often the producer of professional video will supply captions or subtitles for the benefit of disabled persons or for transliteration. Notwithstanding the benefits of enhanced media, a great deal of professionally produced media lacks useful and desirable enhancements. In addition, even when a particular professional media item has one or more enhancement features, that media may lack other desirable features such as specific transliteration or other interesting information related to content of the media. Of course, outside of the area of professional media, the vast majority of existing video and audio material (e.g. YouTube or home video) is nearly completely lacking enhancement features. Thus, there is a huge amount of video and other media in the world lacking desirable enhancement features, such as subtitles and closed captioning.

In response to this situation, the concept of crowd-sourced captioning/subtitling has evolved in the marketplace. For example, KahnAcademy.com provides software tools that allow volunteers to help create dubbed video and foreign language subtitles for educational videos (www.khanacademy.org). During the summer of 2012, Netflix also began soliciting for volunteers to join its crowd sourced subtitling community. There are also other similar efforts by a variety of well know companies: BBC; NPR; Google; Facebook; and Microsoft.

### SUMMARY OF THE DISCLOSURE

Aspects of inventions discussed herein relate to the use of crowd source techniques for providing video enhancement features such as closed captions, subtitles or dubbing. Some embodiments of the invention contemplate using one or more stages of a five-stage process. In a potential first stage of an embodiment, a large number of input-users (typically volunteers) input enhancement information (e.g. captions or subtitles) that is collected by a central system or system operator. The input-users may align the enhancements with places (e.g. temporal places) in the media by use of placement guides such as cue points, which are described more fully below. The input-users may obtain cue point information from a central system or system operator and then apply that information to independently obtained version of the media being enhanced. In some embodiments, many input-users will add all types of enhancements to a media item and a central system or operator will collect all of the enhancements.

After a critical mass of enhancement information is collected by the central system, the five-stage process may move to a second stage that includes normalizing the collected data. Since the normalization task lends itself to machine work, many embodiments use server-based applications to perform normalization. However, other embodiments contemplate using crowd source techniques to perform normalization. For example, enhancements collected from input-users might be transferred in portions to a another grouping of users to perform the normalizing task through crowd sourcing.

In some embodiments, after normalization is complete, the five-stage process may enter a third stage wherein the collected and normalized data is distributed to another group of users (e.g. “editor-users”) for validation and editing. The crowd source of editor-users performs the editing and validation tasks and the results are again collected by the central system or a central operator.

After sufficient crowd-source editing takes place, the five-stage process may enter a fourth stage to curate the now normalized and edited set of data. In the fourth stage, yet another group of users (e.g. “curator-users”) organize the enhancement materials into categories or channels that may be functional (e.g. closed captions), entertaining (e.g. fun facts about the actors' lives during the shooting of the video), or otherwise desirable. For example, curator-users may create streams or channels of enhancement features where each stream or channel follows a potentially desirable theme, such as English close captions, Italian subtitles, information about actors, or any possible interesting aspect of the media content. Thus, after curating, a video may have any number of channels, each channel representing a themed collection of enhancement information available for an end-user.

A final potential stage to the five-stage process involves the publication of the enhancement information. Since the enhancement information may be organized (for purposes of temporal placement in the video) with respect to cue points, the enhancement information may be distributed to the end user independent of the video source. The cue point and enhancement information may be merged with video stream at or near the runtime of the video.

### BRIEF DESCRIPTION OF THE DRAWINGS

FIG. 1 is a simplified functional block diagram of an illustrative electronic device according to one embodiment.

FIG. 2 is an illustrative network architecture within which the disclosed techniques may be implemented.

FIG. 3 is an illustrative software stack.

FIG. 4 is a flow chart for one or more embodiments.

FIG. 5 shows an example embodiment of a media player in connection with one or more embodiments.

FIG. 6 shows a table representing database information in connection with certain embodiments.

FIG. 6b shows other tables related to the table and topic of FIG. 6.

FIG. 7 shows a table of enhancement data.

FIG. 7b shows a table of enhancement data related to the table and topic of FIG. 7.

FIG. 8 shows more tables related to the table and topic of FIG. 7.

FIG. 9 shows an illustrative multi-step process in accordance with some embodiments.

### DETAILED DESCRIPTION

I. Hardware and Software Background

The inventive embodiments described herein may have implication and use in all types of single and multi-processor computing systems. Most of the discussion herein focuses on a common computing configuration having a CPU resource including one or more microprocessors. The discussion is only for illustration and not intended to confine the application of the invention to the disclosed hardware. Other systems having either other known or common hardware configurations are fully contemplated and expected. With that caveat, a typical hardware and software operating environment is discussed below.

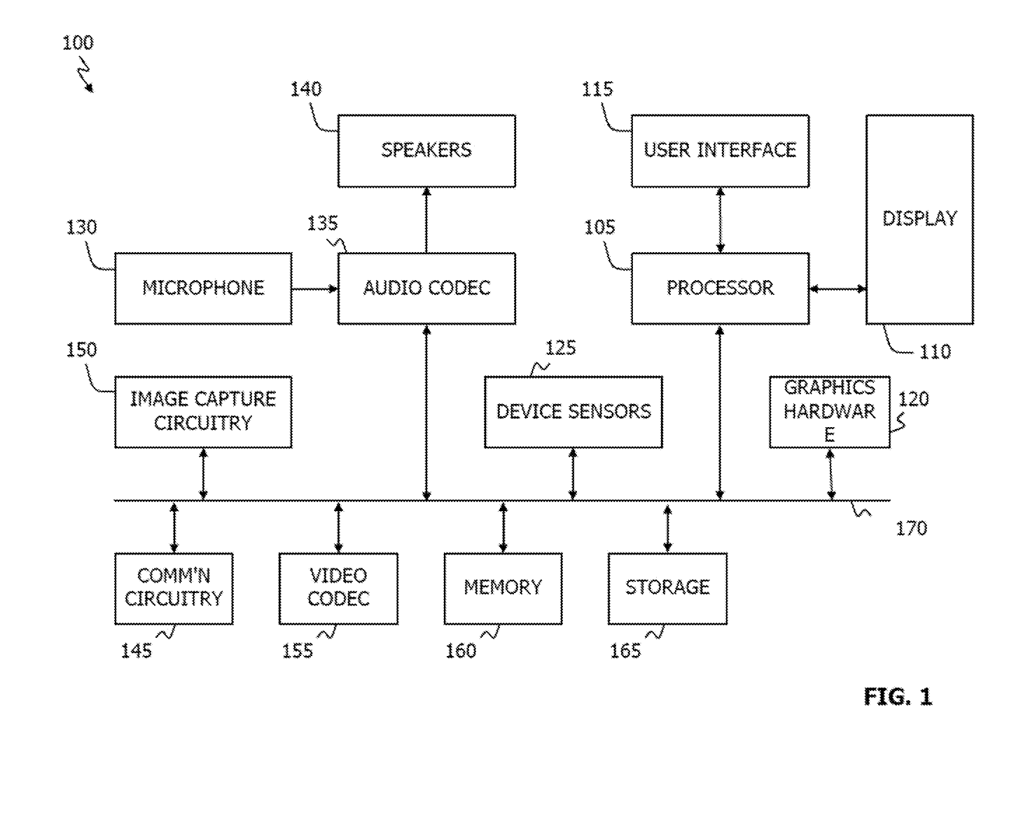

Referring to FIG. 1, a simplified functional block diagram of illustrative electronic device 100 is shown according to one embodiment. Electronic device 100 could be, for example, a mobile telephone, personal media device, portable camera, or a tablet, notebook or desktop computer system or even a server. As shown, electronic device 100 may include processor 105, display 110, user interface 115, graphics hardware 120, device sensors 125 (e.g., proximity sensor/ambient light sensor, accelerometer and/or gyroscope), microphone 130, audio codec(s) 135, speaker(s) 140, communications circuitry 145, digital image capture unit 150, video codec(s) 155, memory 160, storage 165, and communications bus 170. Electronic device 100 may be, for example, a personal digital assistant (PDA), personal music player, a mobile telephone, or a notebook, laptop or tablet computer system.

Processor 105 may execute instructions necessary to carry out or control the operation of many functions performed by device 100 (e.g., such as the generation and/or processing of media enhancements). In general, many of the functions performed herein are based upon a microprocessor acting upon software embodying the function. Processor 105 may, for instance, drive display 110 and receive user input from user interface 115. User interface 115 can take a variety of forms, such as a button, keypad, dial, a click wheel, keyboard, display screen and/or a touch screen, or even a microphone or video camera to capture and interpret input sound/voice or video. The user interface 115 may capture user input for any purpose including for use as enhancements in accordance with the teachings herein.

Processor 105 may be a system-on-chip such as those found in mobile devices and include a dedicated graphics processing unit (GPU). Processor 105 may be based on reduced instruction-set computer (RISC) or complex instruction-set computer (CISC) architectures or any other suitable architecture and may include one or more processing cores. Graphics hardware 120 may be special purpose computational hardware for processing graphics and/or assisting processor 105 process graphics information. In one embodiment, graphics hardware 120 may include a programmable graphics processing unit (GPU).

Sensor and camera circuitry 150 may capture still and video images that may be processed to generate images for any purpose including for use as enhancements in accordance with the teachings herein. Output from camera circuitry 150 may be processed, at least in part, by video codec(s) 155 and/or processor 105 and/or graphics hardware 120, and/or a dedicated image processing unit incorporated within circuitry 150. Images so captured may be stored in memory 160 and/or storage 165. Memory 160 may include one or more different types of media used by processor 105, graphics hardware 120, and image capture circuitry 150 to perform device functions. For example, memory 160 may include memory cache, read-only memory (ROM), and/or random access memory (RAM). Storage 165 may store media (e.g., audio, image and video files), computer program instructions or software including database applications, preference information, device profile information, and any other suitable data. Storage 165 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 160 and storage 165 may be used to retain computer program instructions or code organized into one or more modules and written in any desired computer programming language. When executed by, for example, processor 105 such computer program code may implement one or more of the method steps or functions described herein.

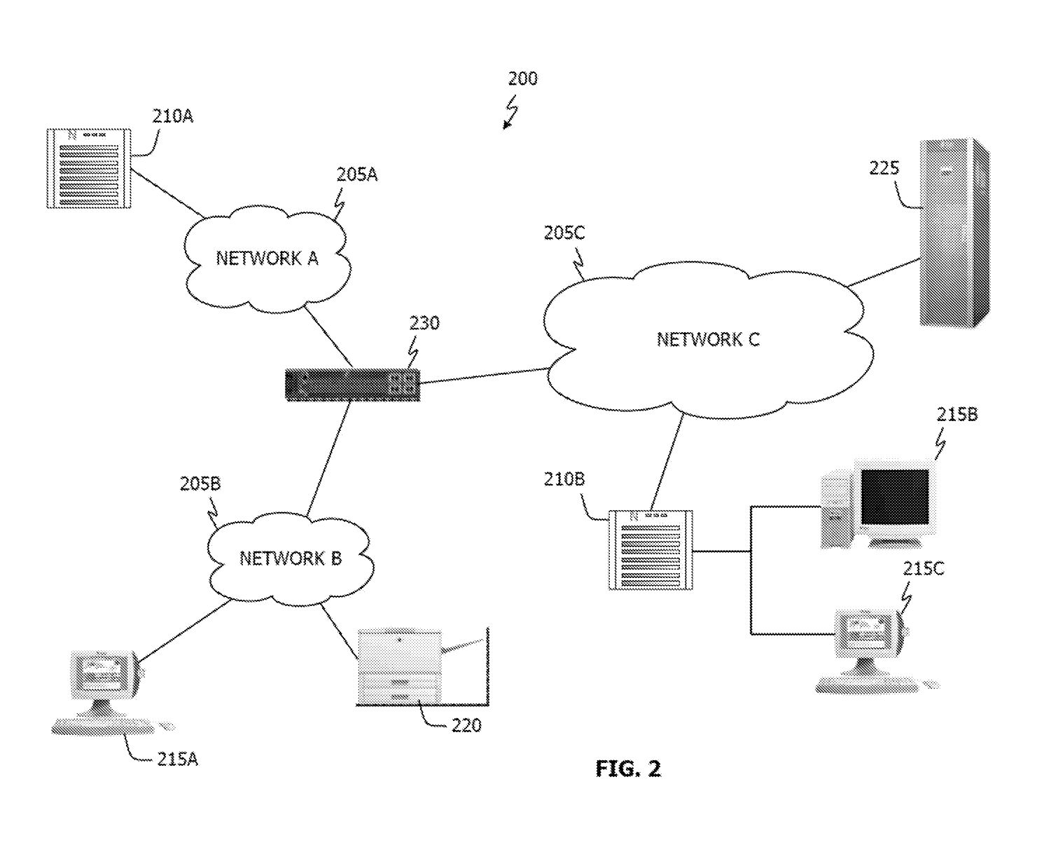

Referring now to FIG. 2, illustrative network architecture 200 within which the disclosed techniques may be implemented includes a plurality of networks 205, (i.e., 205a, 205b and 205c), each of which may take any form including, but not limited to, a local area network (LAN) or a wide area network (WAN) such as the Internet. Further, networks 205 may use any desired technology (wired, wireless or a combination thereof) and protocol (e.g., transmission control protocol, TCP). Coupled to networks 205 are data server computers 210 (i.e., 210a and 210b) that are capable of operating server applications such as databases and also capable of communicating over networks 205. One embodiment using server computers may involve the operation of one or more central systems to collect and distribute information to a crowd source labor force over a network such as the Internet.

Also coupled to networks 205, and/or data server computers 210, are client computers 215 (i.e., 215a, 215b and 215c), which may take the form of any computer, set top box, entertainment device, communications device or intelligent machine, including embedded systems. In some embodiments, users such as input-users, curator-users, editor-users and end-users will employ client computers. Also, in some embodiments, network architecture 210 may also include network printers such as printer 220 and storage systems such as 225, which may be used to store enhancements (including multi-media items) that are referenced in databases discussed herein. To facilitate communication between different network devices (e.g., data servers 210, end-user computers 215, network printer 220 and storage system 225), at least one gateway or router 230 may be optionally coupled there between. Furthermore, in order to facilitate such communication, each device employing the network may comprise a network adapter. For example, if an Ethernet network is desired for communication, each participating device must have an Ethernet adapter or embedded Ethernet capable ICs. Further, the devices must carry network adapters for any network in which they will participate.

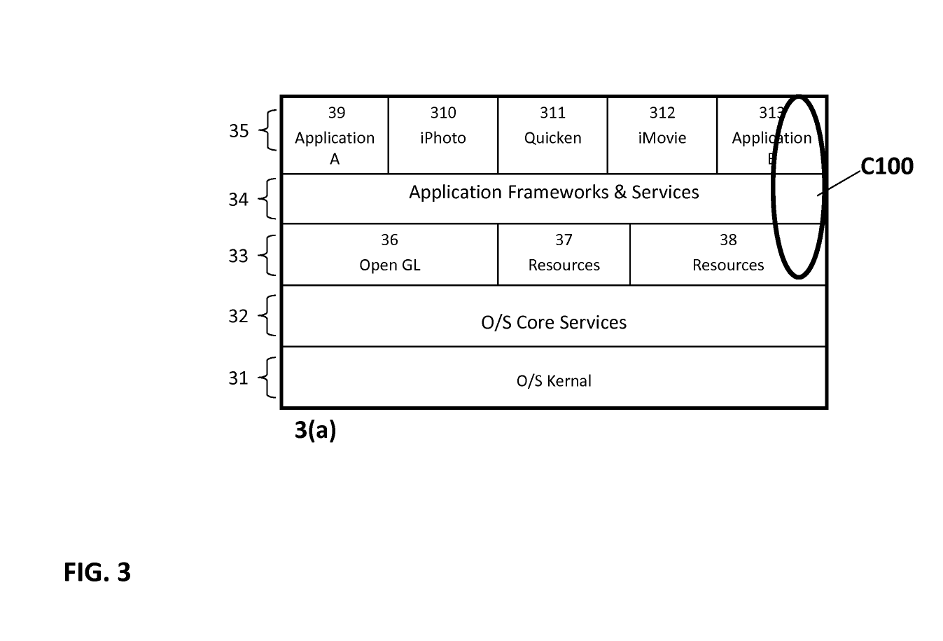

As noted above, embodiments of the inventions disclosed herein include software. As such, a general description of common computing software architecture is provided as expressed in layer diagrams of FIG. 3. Like the hardware examples, the software architecture discussed here is not intended to be exclusive in any way but rather illustrative. This is especially true for layer-type diagrams, which software developers tend to express in somewhat differing ways. In this case, the description begins with layers starting with the O/S kernel so lower level software and firmware has been omitted from the illustration but not from the intended embodiments. The notation employed here is generally intended to imply that software elements shown in a layer use resources from the layers below and provide services to layers above. However, in practice, all components of a particular software element may not behave entirely in that manner.

With those caveats regarding software, referring to FIG. 3 (a), layer 31 is the O/S kernel, which provides core O/S functions in a protected environment Above the O/S kernel, there is layer 32 O/S core services, which extends functional services to the layers above such as disk and communications access. Layer 33 is inserted to show the general relative positioning of the Open GL library and similar resources. Layer 34 is an amalgamation of functions typically expressed as multiple layers: applications frameworks and application services. For purposes of our discussion, these layers provide high-level and often functional support for application programs which reside in the highest layer shown here as item 35. Item C100 is intended to show the general relative positioning of the client side software described for some of the embodiments of the current invention. While the ingenuity of any particular software developer might place the functions of the software described at any place in the software stack, the client side software hereinafter described is generally envisioned as user facing (e.g. in a user application) and/or as a resource for user facing applications to employ functionality related to collection of crowd source information or display of enhanced video features as discussed below. On the server side, certain embodiments described herein may be implemented using server application level software, database software, either possibly including frameworks and a variety of resource modules.

No limitation is intended by these hardware and software descriptions and the varying embodiments of the inventions herein may include any manner of computing device such as Macs, PCs, PDAs, phones, servers or even embedded systems.

II. A Multi-Stage Crowd Source System

Some embodiments discussed herein refer to a multi-stage system and methodology to employ crowd-sourcing techniques for the purpose of creating, refining and ultimately using video enhancement features. For example, a system may collect video captions through crowd sourcing and then distribute the collected captions to volunteer users for further refining and categorization. In this manner, one or more channels of enhancement information may be created by crowd sourcing and applied to media, resulting in products like enhanced video.

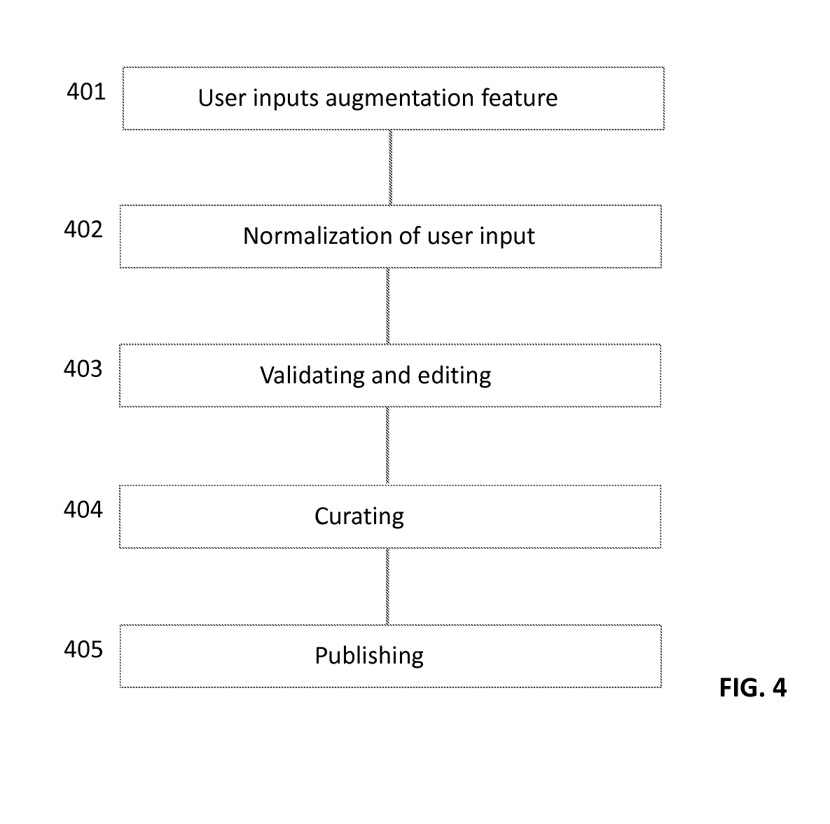

FIG. 4 shows an embodiment relating to a five-stage system and methodology to make and/or exploit enhanced video through crowd sourcing. In the first stage 401, input-users input text or other enhancement information, for example subtitles or captioning. The input-users may be human or machine but are typically volunteers from a community of interested persons. The input-user may employ any type of computing device as generally described above and enter information through a user interface of any known type. In some embodiments, input-users may enter information on a tablet computer such as the Apple iPad, using a touch screen interface or accessory keyboard and mouse. Other embodiments may employ traditional computer I/O such as display screens, mice, touchpads, keyboards, microphones, or video and still cameras. Thus, various embodiments of the invention contemplate input by any known manner including multi-media input such as images, video and speech (including recognition where desired). Given the variety of input possibilities, the user interfaces for those inputs may vary as well. For example, some input devices may be persistently present (e.g. a hardware keyboard, a camera or a microphone), while others may only appear as required (e.g. a touch keyboard).

Referring again to FIG. 4, a second stage 402 of an embodiment may include the task of normalizing user input. During the normalization stage a system or user may employ various techniques to eliminate redundancies and dependencies in the collected enhancement information. As with the user input stage, a normalizing-user may be a human or a machine, such as a server computer. Further, if the normalizing-user is machine-based, some embodiments of the invention contemplate the use of intelligent software such as heuristic software to find redundancies and dependencies, including those that are not obvious or detectible by conventional machine algorithms. Moreover, if the user for the normalization stage is human, the client device and interface employed by the human user may span the known spectrum of such items as discussed herein.

Referring once again to FIG. 4, stage 403 of an inventive embodiment may include validating and editing the content. Some embodiments call for validating and editing after normalization so that, for example, there is no wasted effort validating and editing data that will be eliminated or changed during normalization. However, for purposes of other embodiments (e.g. applying strict functionality), order between these stages is not completely essential. During the validating and editing stage, data is corrected and/or refined with respect to its functional and aesthetic characteristics, such as grammar, punctuation, syntax and style. As with the previous stages, an editor-user for stage 403 may be human or machine and include all of the options and variations discussed above.

Referring yet again to FIG. 4, an embodiment may include a curating stage 404. Generally, some embodiments employ curating to separate content into categories that may serve as independent channels or streams in the enhanced video. The curating stage may be more accurate and efficient in sequence after stages 402 and 403, but for some embodiments (e.g. applying strict and bare functional purposes) no particular order is necessarily required. Further, a curator-user for stage 404 may be human or machine and include all of the device and interface options and variations discussed above.

Finally, referring again to FIG. 4, a publishing stage 405 may be part of an innovative embodiment. The publishing stage represents distribution and use of the cue point and enhancement information so that an end user can enjoy an enhanced video experience. In some embodiments, the cue point and enhancement information is separable from media (e.g. video) information so that a user may employ enhancements on a version of the media acquired independent of the cue point and enhancement information.

Having this overview, each stage will now be explained in further detail.

III. User Input

During the user input stage, enhancement information is collected from multiple users (“input-user”), each of whom presumably views/experiences at least portions of the subject media and “enters” information. An input-user at the input stage may use any conventional device to enter enhancement information. Of course, since many conventional devices provide few or no mechanisms for entry of enhancement information, a conventional device may require the addition of supplementary technology. For example, an input-user may employ a traditional software video player that is supplemented through a simple software update, software plugin or accessory software. Some common traditional video players, which may be supplemented might include Apple's QuickTime player, Microsoft's Windows Media Player, or browser based video players. Some embodiments also contemplate the use of legacy hardware video viewing devices, which may be supplemented for use with embodiments of the invention. For example, many modern televisions and set top boxes may receive plugin or accessory software to add functionality. Furthermore, any legacy video device might be supplemented by use of accessory hardware that connects in serial with the legacy device and provides for a user interface and infrastructure for collecting, editing or curating video enhancement information. In the case of such an accessory hardware device, one embodiment envisions the use of a set top box serially in-line between the video source and the display, such that the accessory may impose a user interface over and/or adjacent to the video.

Of course, an input-user (or other user) may enter enhancement information using a device or software that is made or designed with enhancement entry as a feature. In that event, supplementation may not be necessary.

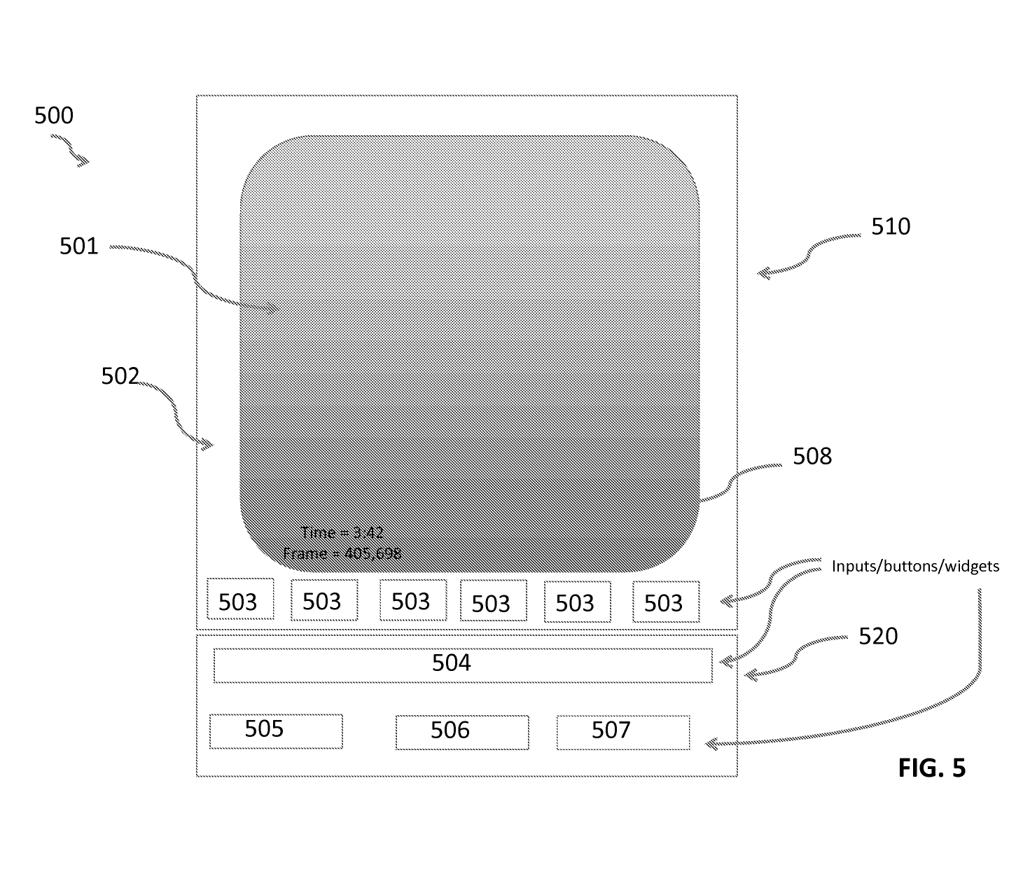

One example embodiment of a media player for use in collecting enhancement information is show as item 500 in FIG. 5. The media player 500 may represent either an ordinary media player that has been supplemented or a media player designed with functionality to collect enhancement information and perform the other tasks required or desirable to the various embodiments discussed herein. Section 510 of item 500 generally corresponds with a traditional media player and comprises: screen or viewing area 501; timeline 508 that may display temporal parameters of the video including beginning time and/or frame number, end time and/or frame number, and the time and/or frame number of the scene currently shown in the display area; and icons or widgets 503. Section 520 of item 500 generally corresponds to supplementary features that provide for user input of enhancement information or other features and functions required or desirable for the various embodiments of the invention. Of course, given that nature of technology and especially software technology, there needn't be any physical separation or aesthetic distinction between section 510 and any component of section 520.

Referring again to section 520, the diagram illustrates potential types of input fields or icons or widgets that might be used by an input-user to enter enhancement information. For example, in one embodiment, item 504 is a text entry box wherein an input-user may directly type enhancement information such as a caption, subtitle or other information. The input-user might then use one or more of items 505, 506 or 507 to indicate (either textually, by menu, button or any other known mechanism) the nature of the information entered in box 504. For example, the user may indicate that the entered information is a caption, entered in English, or alternatively, a URL that is linked to contextual information about something in the media content. As disclosed later, any context (e.g. metadata) provided by the input-user regarding a submitted media enhancement may be stored in a database and used in later stages of the process. In other embodiments, one or more of the widgets or icons (e.g. items 505, 506 or 507) may be drop zones for multimedia items or text items that were produced using a different software tool or different computer. As with the case of text entry, in connection with using a drop zone, the user may use widgets to indicate meta-information such as the nature and/or relevance of the item being dropped. Varying embodiments of the invention contemplate entry of enhancement information by any mechanism possible now or in the future. A further and non-exhaustive list of examples is as follows: a user may employ a pointer to select a arbitrary spot on the display for data entry either during video play or otherwise; a user may enter information through voice recognition either by simply speaking or by using a widget/icon to indicate the insertion of speech; or a user may enter information through use of the sensors in the client device, for example audio or video enhancement through a microphone or camera or any information that a device sensor may obtain. Of course, any combination of the foregoing is also contemplated.

In some embodiments, as enhancement information is input by a user, the information is saved in a memory such as any of the memory discussed in connection FIGS. 1 and 2 above. Since crowd sourcing often involves receiving input from a variety of geographically dispersed locations, the enhancement information may be stored on either or both the user device (e.g. employing an interface such as FIG. 5) and/or a remote device acting as a server or central system that is a gathering point for enhancement information entered by multiple users. Any number of physical embodiments may be envisioned for such and arrangement and reference to FIG. 2 provides ample illustration of user devices networked to each other and/or servers over various local and wide area networks.

Furthermore, as will become evident, the enhancement information receivable by the system may be of multiple types or formats and may relate to multiple categories of information. Also, each item of enhancement information may be tied to a place (e.g. a temporal point) in the media (e.g. video). Therefore, with respect to any particular item of enhancement information, there may be a few or many related data items (e.g. metadata), such as: temporal entry point; type of data; category of data; user identification; user location; type of device or software employed by user; time of information entry; comments from the user; and, any other information inferred from the user's action or expressly entered by the user. Given the breadth of information that may relate to every item of enhanced information, some embodiments employ one or more databases to centrally organize the metadata and relate it to the entered enhancement information.

According to some embodiments of the invention, different users may seek to provide enhancement for the same video title (e.g. “The Sound Of Music”), however each user may obtain a version of the video title from a different source. For example, if four input-users in a crowd source group are attempting to provide English caption information for “The Sound Of Music,” the first user may obtain the movie from HULU, the second user from Netflix, the third user from iTunes and the fourth user from broadcast TV. Using any of the input techniques discussed above, each user might choose a different place in the video (e.g. a temporal point) to place the same caption information. Similarly, for any given span of video, one user may choose to put a large amount of caption information in each of a few places, while another user may chose to put a small amount of caption information in each of several places—the total of information potentially being roughly the same for both users. As a result of either of the foregoing situations, any later effort to organize or reconcile the inputs from multiple users will be complicated by the users' randomly selected and variably numerous insertion points. Therefore some embodiments of the invention contemplate the use of cue points.

Cue points are relatively specific places in media (e.g. a video) that are intended to be generally consistent across varying versions of the same video title. The cue points may be placed by any mechanism that provides for consistency among video versions. Some embodiments use cue points that are specific points in a timeline of the video. Other embodiments align cue points with other content addressable features of a video or with meta-information included with the video. In order to achieve consistent cue points across multiple video versions (of the same video title), some embodiments provide cue points that are evenly temporally spaced between identifiable portions of the video, like the beginning, end or chapter markers. For example, some embodiments may use cue points every 60 seconds from beginning to end of the movie or from beginning to end of each chapter. Other embodiments place cue points relative to scene changes or camera angle changes in the video, which may be automatically detected or identified by human users. For example, some embodiments may place a cue point at every camera angle change. Still other embodiments may evenly temporally displace a fixed number of cue points, where the fixed number depends upon the video title's length and/or genre and/or other editorial or meta information about the video. Finally, cue points may be placed by any combination of the foregoing techniques. For example, there may be a cue point placed at each scene change and, in addition, if there is no subsequent scene change within a fixed amount of time (e.g. 60 seconds), another cue point will be inserted.

In some embodiments, the cue point related information for a particular media title is independent from any particular version of the media. In other words, for any particular video title (e.g. The Sound Of Music), the cue point information (e.g. identity, and/or nature, and/or spacing of cue points) is independent and separable from the video versions (e.g. obtained from HULU, or obtained from iTunes, or obtained from NetFlix, etc.). By this feature, the cue point information may be applied to any version of the media title. For example, the cue point information for a particular video title may be applied to video versions sourced from Netflix, Hulu and iTunes (all theoretically slightly different versions in form, but not in substance). In addition, enhancement information may be aligned with cue points rather than directly with markers embedded in the video media. In this manner, enhancement features may be maintained and distributed independent of the video media or version it represents. The independence provided by the cue point embodiments allows a central system (e.g. server resources) to accumulate, process and maintain cue point and enhancement information in a logical space separate from video media and crowd source user activity.

For the benefit of a more complete illustration, the following section describes exemplary embodiments for inputting enhancement information. While the discussion may recite a sequence and at times semantically enforce that sequence, the inventors intend no sequential limitation on the invention other than those that are strictly functionally necessary or expressly stated as essential.

In an initial step of the input stage, an input-user may select a suitably equipped video player, or alternatively select any video player and apply an appropriate supplement to make the player suitable. The input-user may also select a video and a source for the video, for example, “The Sound Of Music” from iTunes. In some embodiments, the input-user may first select a video or source and during the process receive a notification regarding the opportunity to contribute to a crowd source enhancement of the video. If the user accepts the opportunity, an appropriate video player may be provided or supplemented after the selection of the video or source. The player or supplement (e.g. software modules) may be downloaded from a server over a LAN or WAN such as the Internet. Once an input-user is equipped with a suitable video player and video media, the input-user may use normal media controls (depending upon the viewing device, play, FF, RW, pause, etc.) to view the video. At any point where the input-user is inspired to enter enhancement information, there are several possibilities for doing so: the input-user may simply act to enter an enhancement using a pointer, touch or other interface device on the video; the user may pause the video using the normal control and insert the enhancement using a provided interface such as those shown in FIG. 5; or, the user may pause the video using a special control (e.g. icon/widget) for the enhancement feature where use of that control may activate the interface for inserting enhancement information (e.g. the descriptions of FIG. 5). Of course, the input-user may create or retrieve the content of the enhancement information prior to indicating a desire to make insertions or thereafter.

In some embodiments, during video play, the video player may prompt the user regarding the opportunity to enter enhancement information. The prompts may be based upon any of the following or any combination thereof: the placement of cue points in the video; the relative amount of video played (in time, frames or otherwise) since the last enhancement was entered; scene changes; camera angle changes; or, and content addressed features or meta information.

Regardless of the mechanism for indicating an insertion, after an insertion has been indicated, some embodiments provide a visual indication of the nearest cue point. For example, upon the user's indication that an insertion is desired, the video may pause and the user may be shown the nearest cue point. The cue point may be shown by any of the following: upon indication of a desired insertion, the video may automatically move the nearest cue point and display a temporally accurate still image of the playing video at that point; a relatively small windowed still frame of the video at the cue point may be shown on the display in addition the relatively larger still frame of the playing video at the arbitrary point where the insertion was indicated; a brief video sequence in a relatively small framed window similar to the foregoing; an indication on a time line exposing the location of the cue point relative to a paused place in the video where insertion was indicated; or any combination of the foregoing techniques, wherein for example, a relatively small windowed still frame is shown above the timeline indication and the paused video is shown simultaneously in the main display. Furthermore, using some of the techniques discussed here (e.g. relatively small windowed frames and/or timeline indicators) the interface may visually expose multiple cue points either simultaneously or serially when the play head point is in proximity to the cue point. Moreover, whether or not multiple cue points are simultaneously displayed, the user may select between cue points by use of one or more interface control (e.g. pointer, icons or widgets). For example, the user may examine the video for appropriate cue points by moving forward or backward through sequential cue points. In the case of multiple cue points simultaneously displayed, the user may directly select a desired cue point. In some embodiments, the user may insert the enhancement information either before or after selection of the cue point and the appropriately programmed software will align the two.

The insertion of enhancement information may take any form discussed above or otherwise known. Varying embodiments of the invention provide visual feedback of the insertion information. Thus, when a user types in a caption, the text may remain visible for a period of time either in the insertion widget or otherwise on the screen (e.g. aligned with a timeline indicator). As discussed above, some embodiments of the invention contemplate non-text enhancements and for such items a special preview window may be useful for the user. Upon using non-text enhancement information, some embodiments provide preview information in a window either side-by-side or overlapping (e.g. picture-in-picture style) with the playing video.

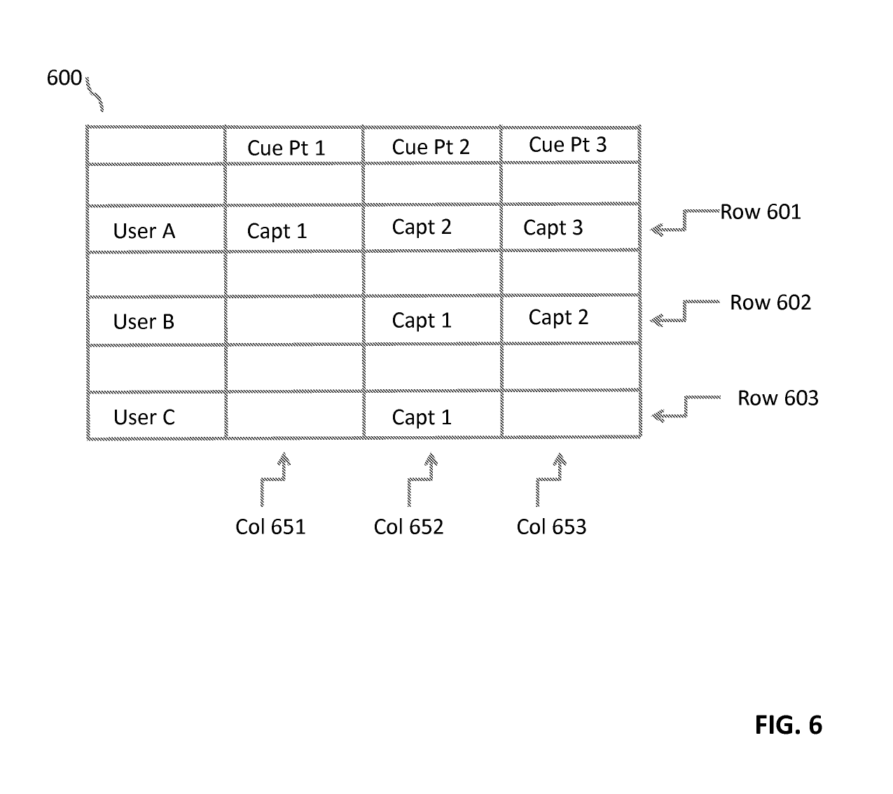

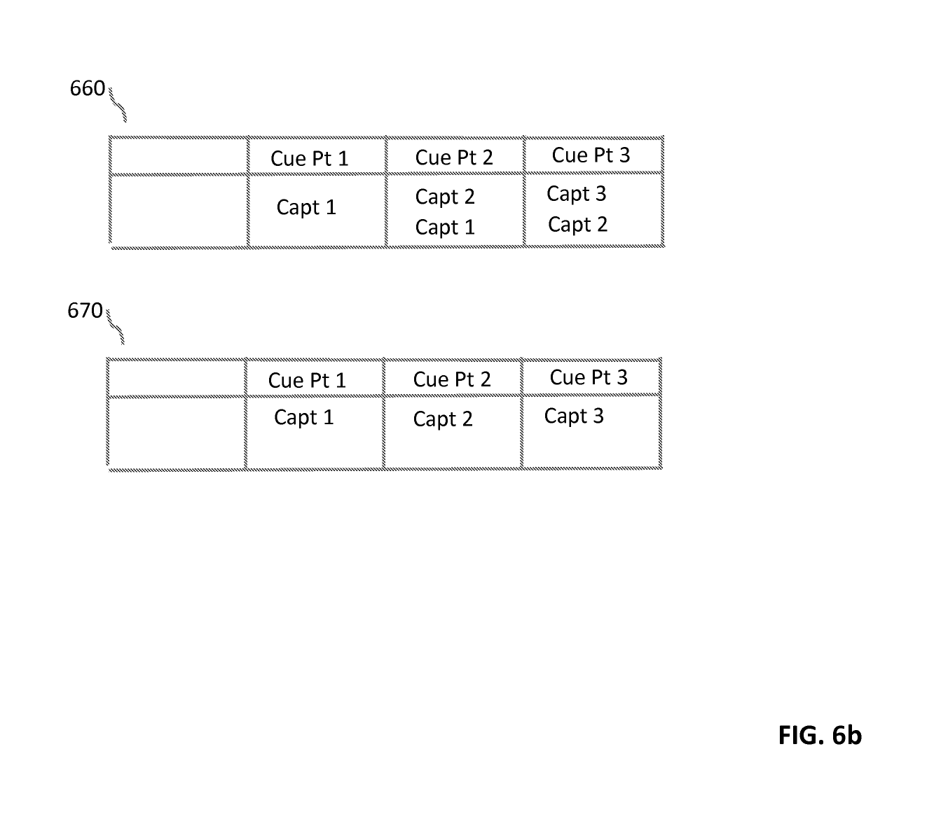

Given the nature of media enhancements such as captioning and subtitles, cue points may be numerous and somewhat close together. This situation suggests that users may not provide content for every cue point. Furthermore, when multiple users provide an enhancement like a caption for the same video sequence, the varying users may not select the same cue point. Therefore, if a networked central system collects enhancement information regarding “The Sound of Music” from several different input-users, the collection of information may be a sparse and intermittently inaccurate as illustrated in FIG. 6 and described below.

Referring to FIG. 6, a table 600 is shown representing database information that may be found on a central system contemplated by certain embodiments. Referring to the table 600, the server appears to collect enhancement data from three users, labeled User A, User B and User C and shown in Row 601, 602 and 603 respectively. A further inspection of table 600 indicates that the users are entering caption information indicated in the chart as Capt 1, Capt 2 and Capt 3. The caption information is placed relative to cue points labeled Cue Pt 1, Cue Pt 2 and Cue Pt 3, which are shown in columns 651, 652 and 653 respectively. For purposes of the illustration, Capt 1 is correctly placed when corresponding with Cue Pt. 1 and so on. Thus, as evident from table 600, only user A (Row 601) has entered captions for all three cue points. Furthermore, User A's entered captions all appear to correspond with the correct cue points (Capt 2 with Cue Pt 2, etc.). User B has entered captions for cue points 2 and 3, but apparently User B has slightly miss-aligned the captions by placing Capt 1 relative to Cue Pt 2 and Capt 2 relative to Cue Pt 3. Finally, User C has only entered one caption and it is miss-aligned. As evident the data collection is sparse because 3 of 9 cells are not populated. It is also intermittently inaccurate because some of the captions appear to be miss-aligned as discussed.

IV. Normalization

As discussed above, varying embodiments contemplate a normalization stage. In computer science, normalization generally refers to the elimination of redundancies and dependencies in data. During the normalization stage the system may employ various techniques to eliminate redundancies and dependencies in the collected information. Referring again to FIG. 6, the table 600 may be interpreted as showing server-based enhancement information collected from input-users in a crowd source community. The table shows data redundancy, at least in that Capt. 1 has been entered by all three users and Capt. 2 has been entered by two of the three users. There are several varying embodiments for normalizing the data in table 600. The variation between the embodiments may depend upon the designer's choice, but also upon whether normalization is performed by a human (such as a crowd source volunteer) or by software/machine. Clearly, a human or sophisticated software may identify and correct substantive redundancies and dependencies that more simple solutions will not. For example, humans or sophisticated software may note a caption redundancy with significant misspelling or a description redundancy where none of the same words are used in the redundant entries.

In some embodiments, the system eliminates redundancies on a cue point basis and leaves alignment (e.g. sequential dependency) issues for resolution at a later stage. For these embodiments, the result of normalization will yield table 660 shown in FIG. 6b. Other embodiments may employ a more intelligent normalization process where alignment and redundancy may both be addressed. In these embodiments, the normalization of table 600 results in table 670 of FIG. 6b. As evident, the data in table 670 has been both flattened and aligned. To be very clear, even if a large number of users is assumed, the system works similarly (e.g. if 2000 users provide input for cue point 2, but 1500 are the same, the system will consolidate the redundant entries).

The foregoing normalization examples are relatively simple because they deal with only one type of enhancement information, namely caption data. As discussed earlier, embodiments of the invention contemplate the use of multiple, many or even infinite categories of enhancement data. The following are some examples:

1. Closed Captions (where each language translation may form another category);

2. Subtitles (where each language translation may form another category);

3. Dubbing information (where each language translation may form another category);

4. Historical context information (links, text, image, video and/or audio, each of which may form a different category);

5. Character context information (links, text, image, video and/or audio, each of which may form a different category);

6. Actor context information (links, text, image, video and/or audio, each of which may form a different category);

7. Context information regarding items in the video (links, text, image, video and/or audio, each of which may form a different category);

8. Context information regarding geography and/or locations related to the video (links, text, image, video and/or audio, each of which may form a different category);

9. Context information regarding salable products in the video (links, text, image, video and/or audio, each of which may form a different category);

10. Advertising information related to aspects of the video, where each aspect may be a different category (links, text, image, video and/or audio, each of which may form a different category);

11. Identification of product placements and/or supplementary information regarding placed products (links, text, image, video and/or audio, each of which may form a different category);

12. Product or item information, such as user manuals, technical tutorials etc. (links, text, image, video and/or audio, each of which may form a different category);

13. Educational information related to aspects of the video, where each aspect may be a different category (links, text, image, video and/or audio, each of which may form a different category);

14. Editorial comment information related to aspects of the video, where each aspect may be a different category (links, text, image, video and/or audio, each of which may form a different category); and

15. The replication of DVD bonus features.

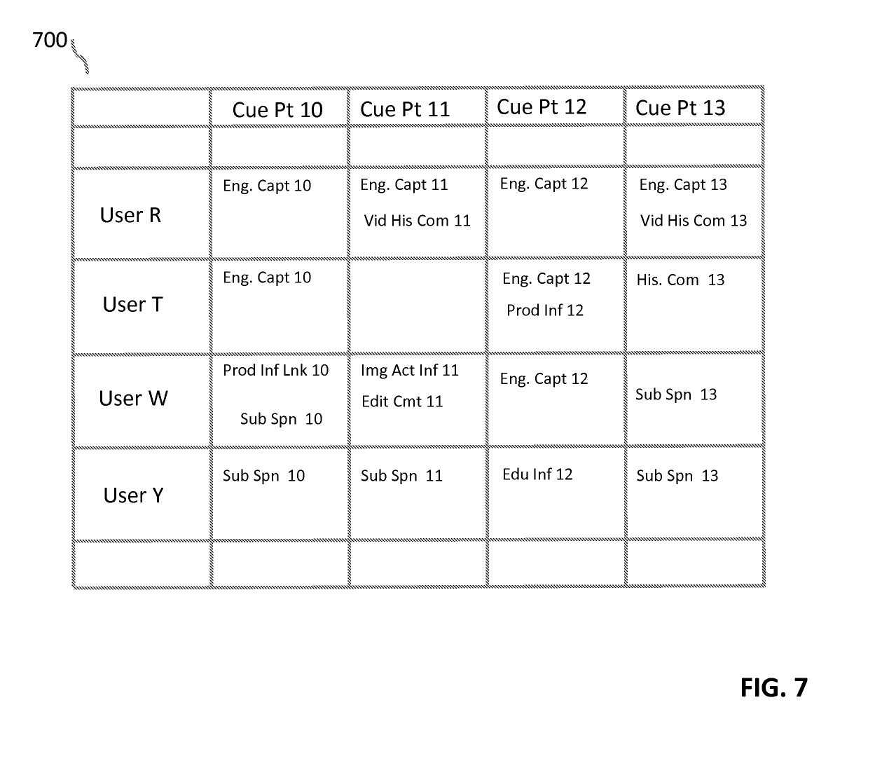

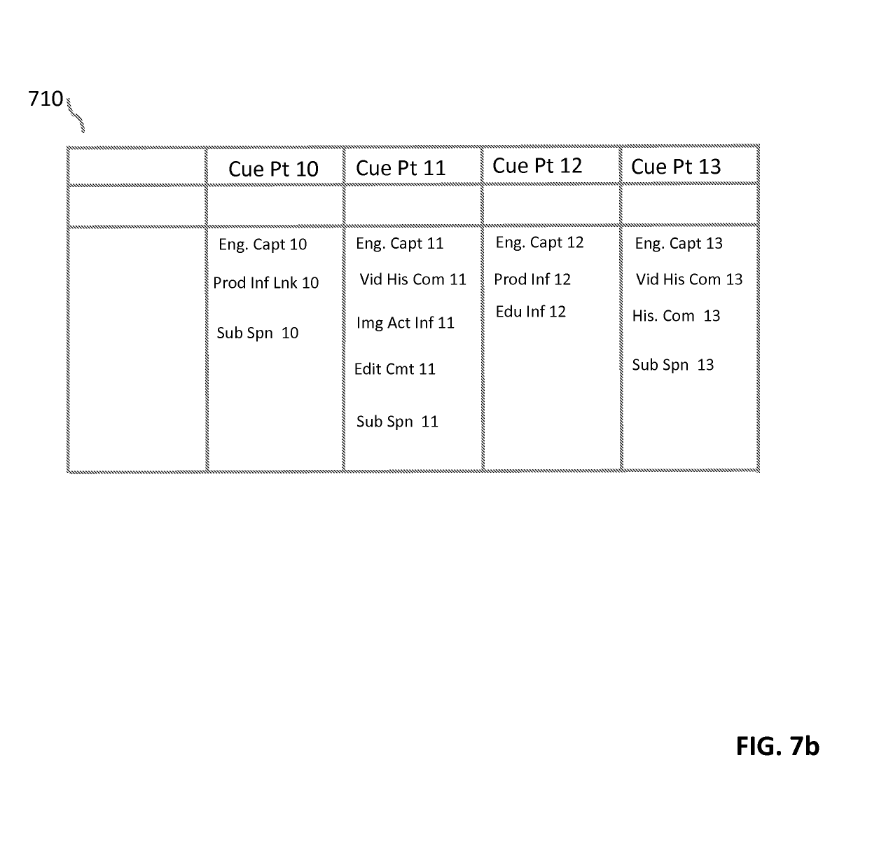

Referring now to FIG. 7, table 700 shows a collection of enhancement data entered by User R, User T, User W and User Y. The data shown in table 7 provides the information entered by users with respect to Cue Pt 10, Cue Pt 11, Cue Pt 12 and Cue Pt 13. The following is evident from table 700, with respect to Cue Pt 10: User R entered English Caption 10; User T entered English Caption 10; User W entered Product Information Link 10, and Subtitle Spanish 10; and User Y entered Subtitle Spanish 10. The following is evident with respect to Cue Pt 11: User R entered English Caption 11, and Vid Historical Commentary 11; User T entered nothing; User W entered Image Actor Information 11, and Editorial Comment 11; and User Y entered Subtitle Spanish 11. The following is evident with respect to Cue Pt 12: User R entered English Caption 12; User T entered English Caption 12, and Product Information 12; User W entered English Caption 12; and User Y entered Educational Information 12. Finally, the following is evident with respect to Cue Pt 13: User R entered English Caption 13, and Video Historical Commentary 13; User T entered Historical Commentary 13; User W entered Subtitle Spanish 13; and User Y entered Subtitle Spanish 13. Note that while the illustration implies the existence of multimedia objects in the database, that many embodiments will simply retain software pointers in the database. The software pointer provides information leading to the actual storage location of a multimedia object either locally or across a LAN or WAN.

In some embodiments, by applying a normalization process to table 700, the system will eliminate redundancies and result in table 710 shown in FIG. 7b. By comparing table 700 with table 710, the following redundancy elimination is evident: with respect to Cue Pt. 10, redundant English Caption 10 and Subtitle Spanish 10 were eliminated; with respect to Cue Pt 11, no redundancies were found or eliminated; with respect to Cue Pt 12, multiple redundant English Captions 12 were eliminated; and, with respect to Cue Pt 13, a single redundant Subtitle Spanish was eliminated. Note that the normalized data shown in the diagrams omits the user attribution information so that the normalization process may be illustrated more easily. However, some embodiments of the invention retain user attribution information, which may become important later when redistributing data for further crowd source refinement or when reprocessing the data after new user entries are received.

V. Validating and Editing Cue Point and Enhancement Information

Certain embodiments employ a validating and editing stage to perform a content editing and policing function well known in the art of crowd sourcing (e.g. Wikipedia). Generally, the editor-users performing validation and editing will correct errors or alter enhancements to improve the published product and police its integrity against sloppy, malicious or abusive participation by others.

Validation and editing users (e.g. editor-user) may be the same or different users from the input-users that provide enhancement entries. Notably, in some embodiments, user identities (or pseudo-identities) are persistently related to enhancement data so that the same user would not be assigned to both enter and edit/validate the same data.

As discussed above with reference to FIG. 5, a user will employ a preconfigured or supplemented hardware/software device to perform tasks such as entry and editing. Given the wide range of data formats for enhancement, the user's device may require a wide range of capabilities in order to effectively edit every type of potential data. In some embodiments, information regarding the user and her device/software is retained in a server/database that may be the same server/database associated with the cue point and enhancement information. This repository may include both information supplied by a user (e.g. name, pseudo-name, languages spoken, location, device type and abilities, special access to information, special editing abilities or expertise, preferred tasks for volunteer participation, preferences for media type, preferences for category of enhancement) and information that may be inferred or gathered by machine (e.g. MAC address, browser types, machine type, operating system).

When employing the validation and editing stage, normalized cue point and enhancement data is distributed to identified and selected editor-users. The normalized data may be distributed to editor-users using several different methodologies. For example, in various embodiments, one or more of the following techniques may be employed in the distribution of enhancement data to editor-users: attempt to prevent a particular editor-user from reviewing enhancement information that was entered by that same person or machine; attempt to provide an editor-user with enhancement information in a language spoken by the editor; attempt to provide each editor-user only with enhancements for which edit and validation does not require any device features that are unavailable for the editor-user; provide the editor-user enhancement information according to the preferences of the editor-user; provide the editor-user enhancement information according to the profile of the editor-user; provide the editor-user enhancement information according to the know abilities and/or disabilities of the editor-user; an editor-user is sent all available cue point and enhancement information; an editor-user is sent cue point and enhancement information that is most desired for editing and/or completion by the system operator (e.g. the server owner/operator); an editor-user is sent cue point and enhancement information that is based upon ratings or comments from the end-user base that employs the enhancements; an editor-user is sent cue point and enhancement information that is based upon ratings or comments from other volunteers in the crowd source community; the editor-user is sent cue point and enhancement information based upon an assessment of the system operator (e.g. server owner/operator) or system software regarding which portions of the subject video are least prepared for publication; an editor-user is sent cue point and enhancement information based upon the number of available editor-users and/or the length of time before scheduled or desired publication; an editor-user is sent cue point and enhancement information based upon the nature of the particular implementation of the overall captioning system; an editor-user is sent cue point and enhancement information based upon the size of the audience interested in a particular video; or, an editor-user is sent cue point and enhancement information based upon the size of the community of user-editors with appropriate expertise or ability to properly edit/validate the material.

In one embodiment, when a potential editor-user is experiencing the media (e.g. watching a video) and wishes to perform editing/validation, the user indicates her desire and, a subset of the available cue point and enhancement information is selected randomly or quasi-randomly for distribution to the user for editing/validation. Any supplementary software may also be sent to the user to facilitate the contemplated editing. Since the user in this case may have already watched a portion of the video, one embodiment allows for supplementing the video with cue point and enhancement information forward from the point currently displayed to the user. Notably, a purpose of this embodiment is not to force the user to watch the video from the beginning or cause the video to shift its play location. This purpose, of course, may be suited even if the entire video is supplemented with cue point and enhancement information.

Furthermore, in distributing cue point and enhancement information to the user-editors, some embodiments are careful not to cause a collision at any cue points. Strictly interpreted, a collision occurs when two or more items of enhancement information are aligned with the same cue point. A reason some embodiments avoid a strict collision is that the user-editor may not be able to decipher multiple enhancements simultaneously. Some embodiments only avoid collisions by preventing multiple enhancements per cue point if the multiple enhancements are not sufficiently complementary (so that they may not be simultaneously critically viewed or experienced).

In some embodiments, during the editing/validation stage, certain designated or all editor-users may be permitted to do one or more of the following tasks in terms of editing: make minor edits in textual content such as fixing typos; edit or delete clearly inappropriate content apparently entered by a malicious or intentionally harmful community member; crop or otherwise edit images, video clips, or audio; edit any enhancement information in any manner known for editing that content; flag content to indicate issues such as profanity, political, religious, commercial, or other content that viewers may want to filter out; flag content that requires the attention of the system operator (e.g. captioning system operator) due, for example, to corruption or error; or, move cue points to better align enhancements with the video.

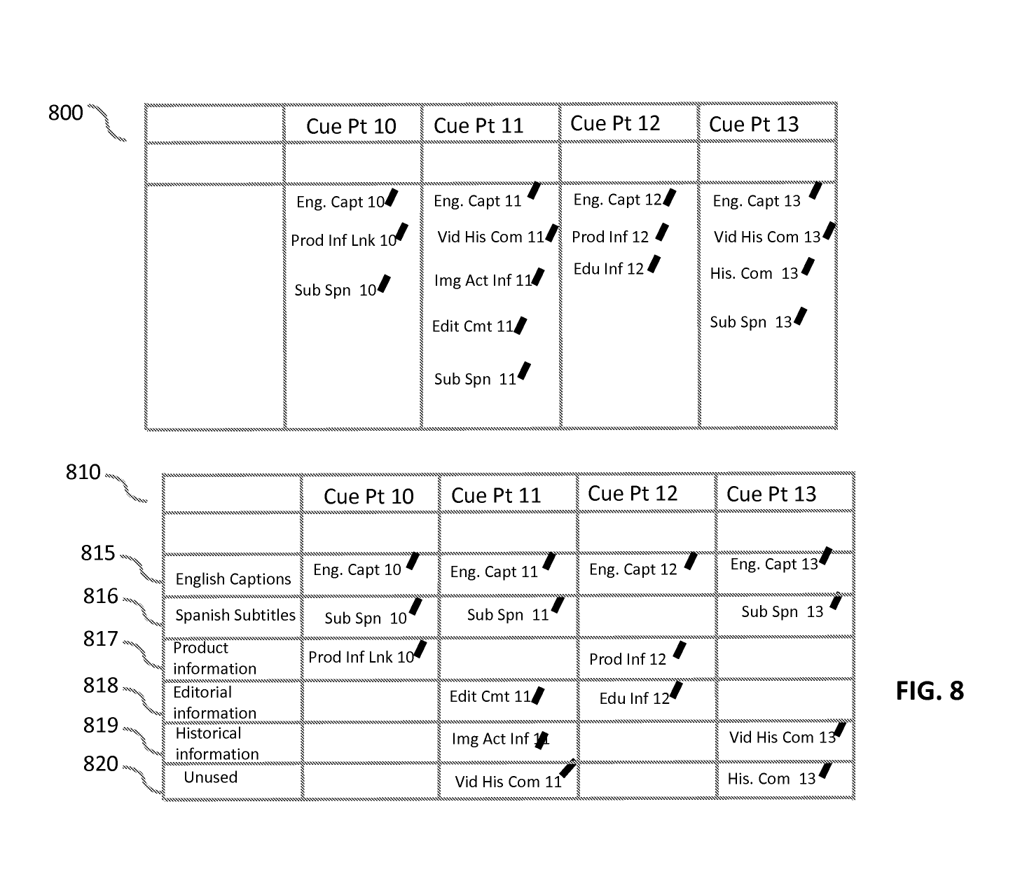

In some embodiments, edited cue point and enhancement information is collected by a server for further use toward publication of an enhanced video. One embodiment provides for incorporating the edited cue point and enhancement information in the same database or a related database as the information exemplified by FIGS. 6 and 7. The result may be logical tables like those shown in FIGS. 6 and 7, however with edited enhancement information. Of course, the database may track both the identity or pseudo identity and meta data about the editor-user as well as the nature of the edits made (e.g. an editing history of the enhancement content). For illustration purposes, FIG. 8 shows table 800, which represents table 710 after the editing and validation changes have been made to the data. The edited status of the data is indicated by the prominent prime marks adjoining each table entry.

VI. Curating the Content

In some embodiments, a curating stage is employed prior to publication of the cue point and enhancement information. This may be performed after the material has been validated, edited and flagged as discussed above.

One benefit of curating the cue point and enhancement information is the opportunity to make enhancement channels that may be based upon the categories of enhancement. For example, if there were enough English and Spanish speaking users entering and editing enhancements, the curating process may be able to form an English closed caption channel and a Spanish subtitle channel. Given the breadth of enhancement information contemplated by varying embodiments of the invention, any number of useful and interesting channels may be derived during the curating process.

In some embodiments, curator-users are a designated group of users that may or may not overlap with input-users and/or editor-users. Some of the embodiments, however, call for curator-users to be professionals or to have greatest trust criteria or to be the most trusted volunteer users in the community. Once designated and/or properly authorized, a curator-user obtains cue point and enhancement data, for example the data represented by table 800 (i.e. edited data). The curator-user may obtain all available cue point and enhancement data or a subset selected by the curator-user or the system operator (e.g. server or service owner/operator). For example, if the editor-user intends only to curate a channel of Spanish subtitles, she may be sent or request only enhancement data comprising Spanish subtitles. If she wishes to be more creative, she may request all Spanish language enhancement data. In terms of the ability to supply or request certain enhancement data, the system may be limited by the description information in its possession for describing the enhancement content. This type of information (i.e. metadata about enhancement content) may be obtained from the input-user, the editor-user or by application of technology to the enhancement information (e.g. text, speech, song, image, face or other object recognition technologies). For example, the more information collected from an input-user through the input interface, the easier the curators job may be.

The curator-user employs the data along with a suitable user interface to assemble logical or aesthetically interesting data channels. While the system operator may provide some rules or guidelines to the curator-user, the role is largely editorial. One curator-editor may produce a channel comprised entirely foreign language subtitles. Another curator-user may select what she considers to be the best of commentary on the symbolism in a movie and populate a channel therewith. Yet another curator-user may populate a channel with selected interesting biographical facts and multimedia artifacts relating to one or more actors in the video. In some embodiments, the curator-user may have even more editorial flexibility such as the full capabilities of an editor-user and/or an input-user. In short, depending upon the embodiment the curator-editor may be given all possible editorial control over the cue point and enhancement information.

Referring again to FIG. 8, table 810 is an illustrative example of how the information represented by table 800 might be curated. With reference to table 810, the curator-user has assembled 6 channels shown by rows 815-820: row 815 is a channel of English captions; row 816 is a channel of Spanish subtitles; row 817 is a channel featuring product information related to the video; row 818 is a channel featuring select editorial and educational information; row 819 is a channel featuring historical information; and row 820 is a channel of otherwise unused enhancement information. Note that the channels are not restricted to a type of enhancement information and that text, images, multimedia and even blanks may be mixed in the same channel.

In addition, while not shown in the example, there is not a strict or technical prohibition against aligning two enhancements with a single cue point in a single channel. This situation could create an aesthetically unpleasant result if assembled accidentally or without care. However, it could also be aesthetically beneficial in certain circumstances such as potentially placing text over video or placing sound with still images.

After the curator-user completes any portion of the curating task, the resulting information may be transferred back to a server/database that may be the same as the servers and databases discussed above or a related server or database.

VII. Publishing

For many embodiments, after a set of cue point and enhancement information is curated, the next stage may be publishing. The publication of one or more channels from a set of cue point and enhancement information (for a particular media title) does not necessary end the potentially ongoing activity of accepting input from input-users, and/or accepting edits from editor-users and/or accepting curated channels from curator-users. For any particular media title, one or more of the five stages described herein may continue indefinitely to the extent desired.

Many embodiments of the invention publish channels of information by making the curated cue point and enhancement information for those channels available over a network (e.g. the Internet) to media player operated by end-users. In one or more embodiment examples, the source of video to a video player is independent of the source of cue point and enhancement information. The player may be preconfigured to obtain available cue point and enhancement information or the end-user may indicate a desire for enhancement channels. In either event, a server in possession of information regarding the available cue point and enhancement information may identify the video to be played by the end user and make any corresponding enhancement channels available to the end-user through the video player interface or otherwise. The available channels may be selectable by the user from any type of known interface, including the following: a text list of available channels; icons representing each available channel; interface elements representing each available channel and embodying a preview of the channels' contents, such as an image. Furthermore, given the crowd sourced nature of the channels, the interface may include scoring or rating information to advise the user regarding the quality or desirability of the enhancement channel. For example, the channel may be scored for accuracy, completeness, entertainment value, quality or any objective or subjective criteria. Furthermore, the source of scoring or rating information may be the crowd source contributors or the end users or both. If score and rating is obtained from multiple groups of users (e.g. end-users, input-users, editor/users, and curator-users) the invention contemplates that ratings or scores may be displayed independently for each group or any combination of groups. For example, a curator's ratings might be particularly useful regarding the completeness or accuracy of a channel.

In some embodiments, depending upon the capabilities of the end-user's player device, the end user may select one or more channels for use at any one time. For example, in some embodiments, the interface will only present channels for selection if the end user's machine/software has the capability to use the channel. While users may commonly simply select only one channel from among close captioning, foreign language dubbing or foreign language subtitles, the invention contemplates that several may be selected simultaneously according to the ability of the player. For example, an end user may select Spanish dubbing and Spanish subtitles. Further, with the use of a proper multi-window interface, the same end user may also simultaneously select several image-based channels such as product information, actor information, maps of related geographies, etc. For example, with or without a multi-window interface, enhancements may complement a video in any number of known ways including the following: dividing the video display into two or more segments (e.g ⅓ and ⅔ horizontally or vertically); opaquely overlay a portion of the video; translucently or transparently overlay a portion of the video; appear in software windows or hardware screens adjacent to the video; play through the same speakers as the video; or play through separate speakers from the video.

In one embodiment, the interface for user selection of available channels may suggest to the end user combinations of channels that are appropriate for simultaneous use. In addition, given the advertising abilities of the system disclosed herein, a user may receive compensation for employing an advertising-related channel during the play of the video. For example, the user may receive free or discounted access to the video or the user may acquire point/value in a loyalty program that can later be exchanged for tangible valuables.

While many embodiments provide for enhancement information to be independent of the video, other embodiments allow for embedding enhancement information with videos by any known mechanism. Therefore, for example, DVD or online video downloads may have enhancement information embedded.

VIII. Interactive Walk Through Five Stages

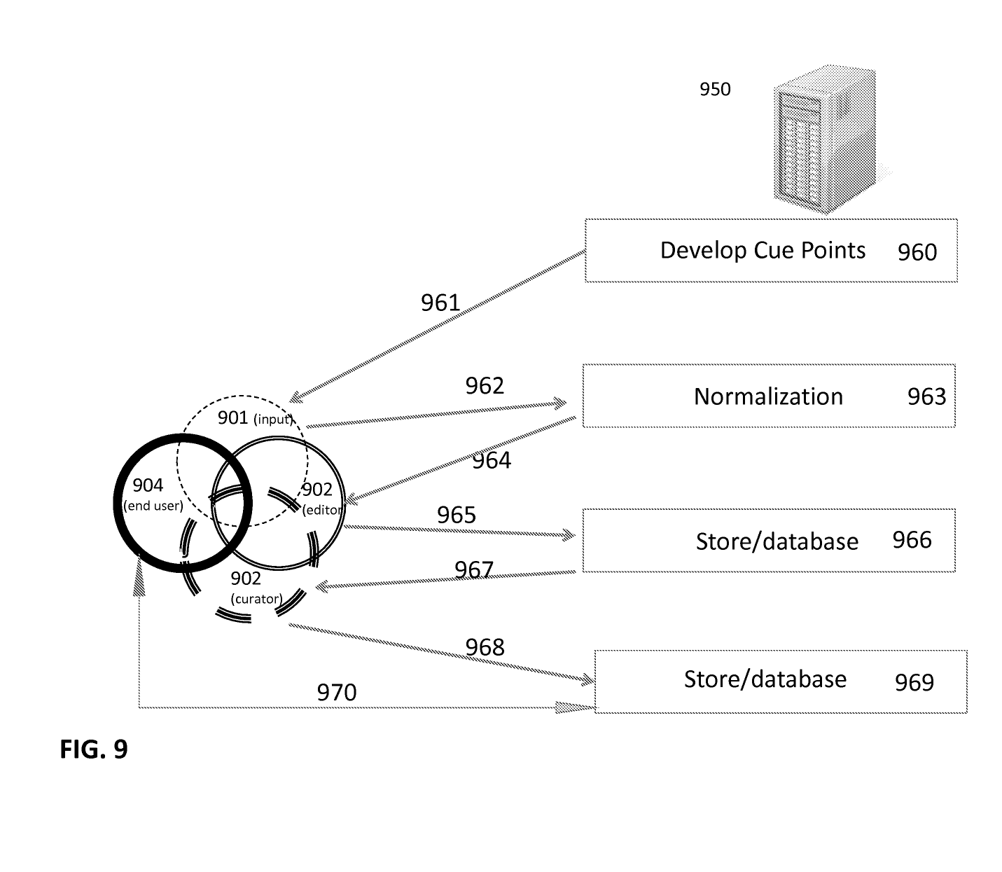

Having described a variety of embodiments and features of the instant inventions, a practical review of the five described stages will now be provided. With reference to FIG. 9, items 901, 902, 903 and 904 are each circles representing a group of users. Circle 901 represents input-users described above. Circle 902 represents editor-users described above. Circle 903 represents curator-users described above. And, finally, circle 904 represents end-users described above. The circles overlay each other in a way that suggests that members of any one group may be either: members of no other group; members of two other groups; or members of all four groups. The selection and placement of persons in a user group is at the discretion of the system operator, although certain embodiments of the invention contemplate a common or known assignment of responsibilities consistent with publically known crowd source systems. In some embodiments, there are separate characteristics, criteria, requirements or conditions for each group of users, although it may be possible for a single user to fit all of those characteristics, criteria, requirements or conditions.

Item 950 is a server intended to represent a server infrastructure including storage that may comprise multiple servers and databases networked together over LANs, WANs or using other connection technology. The server 950 is managed and/or its operation relating to embodiments of the invention is controlled by a system operator or service provider who may or may not be the owner of the server(s) and other equipment.

The disclosed processes of creating enhanced video or facilitating the creation of enhanced media may entail several interactions between server 950 and persons performing work toward the creation of the enhanced media. The server 950 and its included databases may be employed to retain information about the interactions and the devices, software and persons involved in the interactions. Essentially, any information about the process or a person, software, device, or the actions of a person (e.g. edits) may be stored in the server 950 and related to other associated information.

Referring now to step 960, using server 950 or another computer, cue point information is developed for one or more videos and stored. In an exemplary process, digitized video information is loaded into the computer memory where it is evaluated or operated upon by the application of software with a CPU; the result of the evaluation and operations being the creation of cue point information for the video.

Referring now to the transition element 961, upon request or indication from a input-user or her device, some or all of the cue point information is transferred to the input/editor, who may be selected by the system operator from the group of input-users 901. The input-user provides enhancement information as discussed above and the results are returned to server 950 at transition step 962. The steps 961 through 962 may be repeated numerous times to produce a critical mass of enhancement information related to the media and received and stored by server 950. As discussed above, server 950 may employ one or more relational databases and drive arrays to organize and retain information about the ongoing process such as cue point and enhancement information for a media title.

Once the system operator or system software determines there is sufficient enhancement information for a given media title, the server 950 may normalize the data at step 963 and as explained above. In some embodiments, the practical operation of normalization involves loading cue point and/or enhancement information into memory and applying software to a CPU in order to determine the similarity between different input-user entries and to evaluate relationships between the multiple entries or between the entries and the cue points.

Having a normalized set of cue point and enhancement information for a media title, the server 950 may receive a request or notification from one or more editor-users or their devices. In response or on its own programmed initiative, server 950 may forward portions (including the entirety) of the information set to editor-users selected from the editor group of editor-users 902. The editor-users edit cue point and enhancement information and return the results 965 to the server 950 where the results are received and the database or other storage updated 966.

Upon request or notification from any curator-users or their devices, server 950 may forward portions of edited cue point and enhancement information to one or more curator-users 902. The curator-users curate the information essentially preparing it for publication and return the results 968 to server 950 where the results are received and the database or other storage updated 969. Upon the interaction of software with a CPU, server 950 may further process the curated information in final preparation for publication.

One or more end users 904 may obtain media from any source, whether related to the central system or completely independent thereof. For example, a user may obtain video from YouTube or Netflix while Apple Inc. may act as the system operator and create enhancement information through its iTunes community. The end user 904 or her video player may notify server 950 regarding the identity of a media title, and server 950 may respond by providing cue point and enhancement information that the end user's device and software may associate with the independently acquired video. In this manner, the end user may receive the benefit of an enhanced video.

The discussions herein are intended for illustration and not limitation regarding the concepts disclosed. Unless expressly stated as such, none of the foregoing comments are intended and unequivocal statements limiting the meaning of any known term or the application of any concept.

What is claimed is:

1. A method comprising the steps of:
distributing, to each of a plurality of input-users, first data, which indicates locations for enhancement insertions within a plurality of versions of a media title;
receiving, from each of two or more of the plurality of input-users second data wherein second data comprises enhancement items and, for each enhancement item, a corresponding indication of location within a version of the media title;
combining the second data received from a plurality of input users to form a set of combined enhancement data;
distributing the set of combined enhancement data or a portion thereof to each of a plurality of editor-users;
receiving third data from each of one or more of the plurality of editor-users, each third data representing an editor-user's review of a portion of the set of combined enhancement data, wherein the combination of third datas received from one or more editor users forms a set of edited enhancement data;
distributing the set of edited enhancement data, or a portion thereof, to each of one or more curator-users; and
receiving, from at least one curator-user, fourth data comprising, data that associates a first plurality of enhancement items with a common theme, and for each of the first plurality of enhancement items, data that indicates a corresponding location in a version of the media item.

2. The method of claim 1 wherein the distributing to each of the plurality of input-users occurs over the Internet.

3. The method of claim 1 wherein the set of combined enhancement data is normalized prior to distributing the set of combined enhancement data or a portion thereof to each of a plurality of editor-users.

4. The method of claim 2 wherein the distributing to each of the plurality of editor-users occurs over the Internet.

5. A method comprising the steps of:
distributing first cue point information, or portions thereof, to each of a plurality of input-users, wherein the first cue point information indicates a plurality of enhancement insertion locations within versions of a media title;
receiving, from a first input user of the plurality of input-users, first enhancement information, which is based, at least in part, on the combination of a portion of the first cue point information with a first version of the media title;
receiving, from a second input user of the plurality of input-users, second enhancement information based, at least in part, on the combination of a portion of the first cue point information with a second version of the media title;
combining at least a portion of the first enhancement information with at least a portion of the second enhancement information to form combined enhancement information;
normalizing the combined enhancement information or a portion thereof to form normalized enhancement information;
distributing the normalized enhancement information, or portions thereof, to each of a plurality of editor-users;
receiving a response from each of one or more of the plurality of editor-users, each response based upon a portion of the normalized enhancement information, and wherein one or more combined responses form a set of edited enhancement information;
distributing the set of edited enhancement information, or portions thereof, to each of one or more curator-users; and
receiving, from at least one curator-user,
(i) information relating a plurality of enhancement items to a first theme, and
(ii) for each related enhancement item, a cue point indication, wherein the cue point corresponds to the approximate same location in a plurality of versions of the media title.

6. The method of claim 5 wherein the first version of the media title and the second version of the media title differ due to the source of the media.

7. The method of claim 6 wherein first enhancement information and second enhancement information each comprise a plurality of enhancement items and for each enhancement item, an indication of corresponding insertion location selected from first cue point information.

8. The method of claim 7 wherein the step of normalizing the combined enhancement information or a portion thereof, comprises eliminating duplicate enhancement items.

9. The method of 8 wherein duplicate enhancement items are eliminated by comparing one or more enhancement items received from the first input user with one or more enhancement items received from the second user and identifying substantive similarity.

10. The method of claim 9 wherein substantive similarity comprises some identical text.

11. The method of claim 9 wherein substantive similarity comprises some identical meaning.

12. The method of claim 5 wherein the first theme is one of English closed captions, Spanish subtitles, Spanish dubbing, actor information, or product information.

13. The method of claim 5 wherein there is also received from the at least on curator-user, information relating at least one enhancement items to a second theme that is different from the first theme.

14. A method comprising the steps of:
receiving by an end-user a version of a media title;
receiving, by the end-user, independent of the version of the media title, a set of cue point and enhancement information associated with the media title, wherein the set of cue point and enhancement information comprises,
(i) information regarding locations within versions of the media title for insertion of enhancement information, and
(ii) data defining a plurality of channels of enhancement information, each channel comprising a plurality of enhancement items;
aligning the set of cue point and enhancement information with the received version of the media title by,
associating each enhancement item with a location within the version by using the information regarding locations; and
separating the enhancement items into the plurality of channels by using the data defining a plurality of channels; and
providing a user interface allowing the end-user to experience the received version of the media title with a choice augmenting the experience with one or more of the plurality of channels.

15. The method of claim 14 wherein the data defining a plurality of channels of enhancement information is derived from a plurality of contributions, each contribution provided by a different input-user and comprising a plurality of media items.

16. The method of claim 15 wherein the input-users are volunteers and communicate with a service provider over the Internet.

17. The method of claim 14 wherein the data defining a plurality of channels of enhancement information is derived from a plurality of contributions, each contribution provided by a different editor-user and comprising a correction.

18. The method of claim 17 wherein the editor-users are volunteers and communicate with a service provider over the Internet.

19. The method of claim 14 wherein the data defining a plurality of channels of enhancement information is derived from a plurality of contributions, each contribution provided by a different curator-user and comprising an alignment of a media item with a theme.

20. The method of claim 17 wherein the curator-users are volunteers and communicate with a service provider over the Internet.

21. The method of claim 14 wherein the cue point and enhancement information is received independent of the version of the media title because it is received from different source and over the Internet.

22. A computer system comprising:
a media player software module stored in a first memory adapted to play augmented video allowing a user to experience a version of a media title along with enhancement features;
a plurality of enhancement items stored in the first memory, each enhancement item associated with meta data providing information to align the enhancement item with a cue point and with a channel, wherein a cue point indicates a location in the version of the media title and the channel indicates a common theme of media items;
said meta data also stored in the first memory, the meta data having been derived from information supplied by a plurality of input-users, a plurality of editor-users and at least one curator; wherein each input-user contributed at least one enhancement item, each editor-user contributed data editing an enhancement item or relating an enhancement item to a cue point; and
the curator-user contributed data regarding categorizing enhancement items into a channel.

23. The system of claim 22 wherein the common theme is one of English closed captions, Spanish subtitles, Spanish dubbing, actor information, or product information.

24. The system of claim 22 wherein the editor-users and input-users are volunteers communicating with a service provider over the Internet.

25. The system of claim 22 wherein the media player software module stored in the first memory is the combination of an original media player software module and an update software module downloaded over the Internet.

26. The system of claim 22 wherein the metadata is stored in a database.

27. The system of claim 22 wherein the first memory is volatile memory.

28. The system of claim 22 wherein the first memory is non-volatile memory.
